(19) United States
(12) Patent Application Publication
(10) Pub. No.: US 2008/0075522 A1
(43) Pub. Date: Mar. 27, 2008

(54) Method and apparatus for applying a work material

(76) Inventor: Tracy Shoji Ito, Reedley, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/525,461

(22) Filed: Sep. 22, 2006

(51) Int. Cl. B43K 5/02

(52) U.S. Cl. 401/143

(57) ABSTRACT

A method for applying a work material including the steps of intermixing the work material with a flowable carrier substance to form a flowable applying medium consisting of the work material and the carrier substance; and housing the applying medium in a container selectively operable to permit release of the applying medium from the container for receipt on a target spaced therefrom. An apparatus for applying a work material including a container having an internal chamber communicating with the exterior of the container through an aperture, a mechanism mounted on the container for selectively opening and closing the aperture, and an applying medium housed within the chamber of the container having a consistency permitting release through the aperture of the container toward a target spaced therefrom upon operation of the mechanism.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a method and apparatus for applying a work material and, more specifically, to a method and apparatus having particular utility in dispensing substances under such conditions and with such precision as substantially to improve upon the manner in which such substances can be applied.

(2) Description of the Prior Art

The usage of a wide variety of types of substances is compromised, in various respects, due to considerations both relating to the nature of the substance itself, the manner in which it is conventionally applied, as well as to less evident factors such as custom, carelessness, a lack of awareness, time limitations, and the like. Being so compromised can have adverse consequences depending, of course, upon the particular substance involved and the use to which the substance is put. Contamination of the substance itself, or the object to which the substance is applied may be common. While this may be considered the norm, it is nonetheless unsatisfactory.

For example, while the application of a dentifrice to the teeth using a toothbrush is considered a necessary daily practice in the maintenance of adequate dental hygiene, common practices associated therewith frequently compromise the salutary affects thereof. Thus, it is a common practice for family members to use the same tube or container of the dentifrice to be applied. The typical method of application of the dentifrice to be used by each family member is by direct contact of the nozzle of the tube with the bristles of the toothbrush. The application of pressure to the outside of the tube extrudes the desired quantity of dentifrice onto the bristles. As a direct consequence, the nozzle, bristles of the toothbrush and dentifrice both within the tube and received on the bristles are contaminated by direct association with microorganisms borne by anyone or more of them. This process, usually repeated several times a day by each family member and without adequate cleaning or sterilization beforehand, is a practice conducive to the transmission of communicable diseases.

In combination with this practice, the immediate environment in which it takes place encourages such contamination. The dentifrice itself is most commonly a paste which readily attracts and retains deleterious substances. The bristles of the toothbrush as well as the interstices between and amongst the bristles deploy the paste for transfer as well as capture the paste so as to render removal during cleaning substantially impossible. The head of the toothbrush underlying the bristles provides further surfaces aiding in the capture of the paste and substances borne thereby.

These circumstances are exacerbated by a variety of other conditions. Typically, toothbrushes, dentifrice containers and the like are stored in such environments as bathrooms, offices, temporarily in hotel rooms and in luggage and in other areas which contain contaminants. Such locations are commonly warm and damp and thereby serve as fertile habitats for the rapid growth and communication of microorganisms. Such locations are typically lacking in cleanliness and are commonly exposed to other persons, animals, insects, organisms and the like which may carry communicable diseases. Such communicable diseases may thus be transferred to one or more of the dental articles and thereby to those using the dental articles.

Therefore, it has long been known that it would be desirable to have a method and apparatus for applying a work material which permit the work material to be applied to a predetermined target area with accuracy and precision while minimizing the risk of contamination during such application; which can be adapted to a wide variety of specific uses; which have particular utility in dental usages; which assist in improving dental hygiene beyond that which has heretofore been possible; and which, for these and other reasons, afford a comfort in use which promotes optimum practices with regard to dental hygiene.

### BRIEF SUMMARY OF THE INVENTION

Therefore, it is an object of the present invention to provide an improved method and apparatus for applying a work material.

Another object is to provide such a method and apparatus which can be employed to apply a work material to a target area with an accuracy and precision not heretofore achieved.

Another object is to provide such a method and apparatus which cooperate in use to permit the transfer of a work material to a target area while minimizing the risk of contamination.

Another object is to provide such a method and apparatus which are particularly well suited to usage in maintaining dental hygiene at a higher standard of care than has heretofore been possible.

Another object is to provide such a method and apparatus which, in use, minimize the possibility of contamination in the use of dental articles.

Another object is to provide such a method and apparatus which can be employed in such a manner as to maintain both the existence and appearance of a sanitary environment.

Another object is to provide such a method and apparatus which are well suited to usage with a wide variety of types of substances and materials for the purposes desired to be achieved.

Another object is to provide such a method and apparatus which are operable in a wide variety of environments to achieve their operative objectives.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a method and apparatus for applying a work material including the steps of intermixing the work material with a flowable carrier substance to form a flowable applying medium consisting of the work material and the carrier substance, and housing the applying medium in a container selectively operable to permit release of the applying medium from the container for receipt on a target spaced from the container.

### BRIEF DESCRIPTION OF THE SEVERAL VIEWS OF THE DRAWINGS

FIG. 1 is a perspective view of the apparatus of the present invention shown in a typical operative environment.

FIG. 2 is a rear elevation of the apparatus of FIG. 1.

FIG. 3 is a side elevation of the apparatus of FIG. 1.

FIG. 4 is a front elevation of the apparatus of FIG. 1.

FIG. 5 is a top plan view elevation of the apparatus of FIG. 1.

FIG. 6 is a three quarter elevational view of the apparatus of FIG. 1.

FIG. 7 is an exploded three quarter elevational view of the apparatus of FIG. 1.

FIG. 8 is a longitudinal vertical section taken on line 8-8 in FIG. 6.

### DETAILED DESCRIPTION OF THE INVENTION

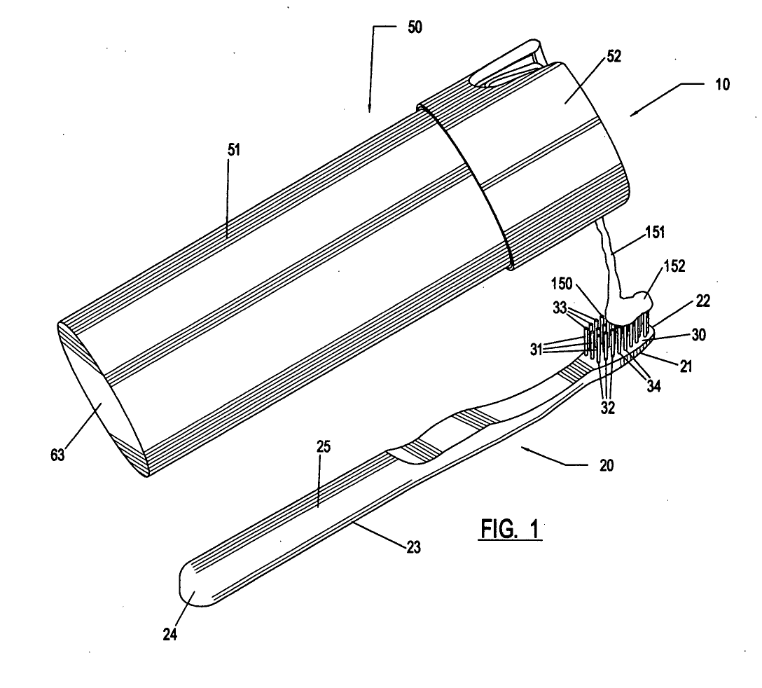

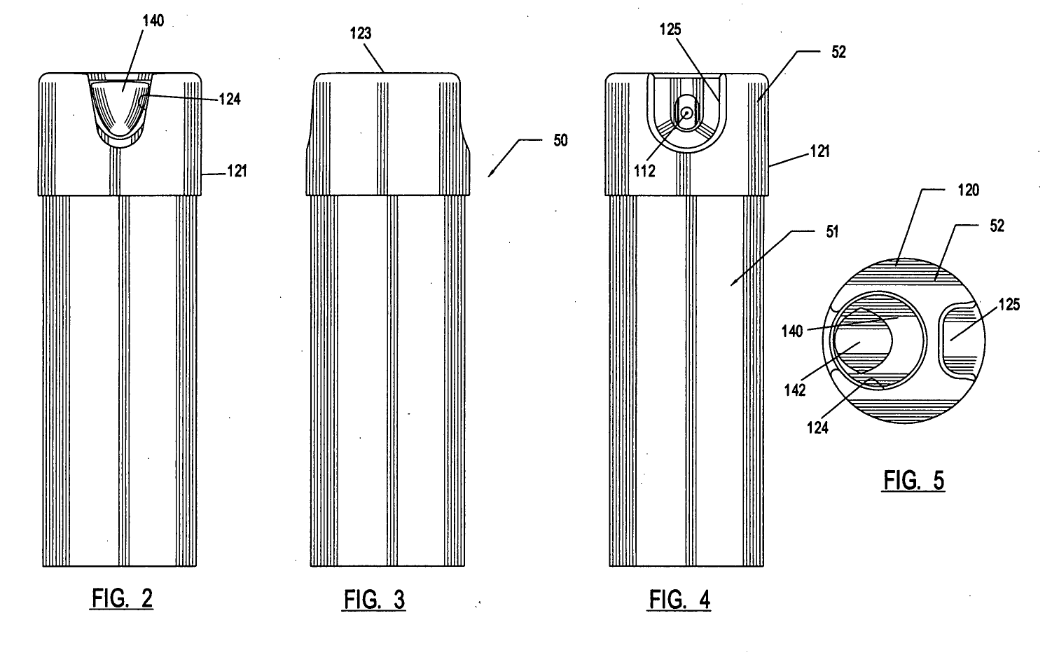

Referring more particularly to the drawings, the apparatus of the present invention is generally indicated by the numeral 10 in FIG. 1. The apparatus is shown in FIG. 1 in a typical operative environment in the use of a dentifrice for the purpose of brushing the teeth. As will become more clearly apparent, the method and apparatus of the present invention have application to usage in a wide variety of operative environments, but have particular utility in the application of a dentifrice using a toothbrush. The toothbrush can be of any suitable type including a manual or electrically powered toothbrush.

As shown in FIG. 1, a toothbrush is generally indicated by numeral 20. For illustrative convenience, the toothbrush as shown and described herein is of the manual type. The toothbrush as shown in FIG. 1 is of a conventional construction having a head portion 21 with a terminal end 22. The toothbrush, opposite the head portion, has a handle portion 23 with a proximal end 24. The handle portion thus forms a shaft 25 interconnecting the proximal end 24 and the head portion 21.

The head portion 21 of the toothbrush 20 has a substantially flat mounting surface 30. A plurality of bristles 31 are mounted on and extend upwardly from the mounting surface 30 substantially at right angles thereto. Each of the bristles has a mounting end portion 32, mounted on the mounting surface 30, and an opposite brushing end portion 33 deployed for brushing engagement with teeth during use. It will be understood that each of the bristles 31 can be of any desired type including those constructed of either single or multiple plastic strands. In the case of the toothbrush 20 the bristles can be viewed as having brushing end portions 33 deployed in a plane substantially parallel to the plane defined by the substantially flat mounting surface 30. The outer surface of the brushing end portion of each bristle is disposed at an angle relative to the longitudinal axis of the bristle. The bristles are spaced from each other, as shown in FIG. 1, thereby defining interstices 34 between adjoining bristles.

The apparatus 10 of the present invention, as shown in the several views of the drawings, has a container generally indicated by the numeral 50. The container includes a canister portion 51 and a cap portion 52. The canister portion is preferably metal and the cap portion is preferably a light weight material such as plastic. The canister portion, as best shown in FIG. 8, has a cylindrical side wall 60 with cylindrical exterior surface 62. The canister portion has a bottom end wall 63 with an interior surface 64 and an exterior surface 65. The cylindrical side wall has a circular upper annulus 66 opposite the bottom end wall 63.

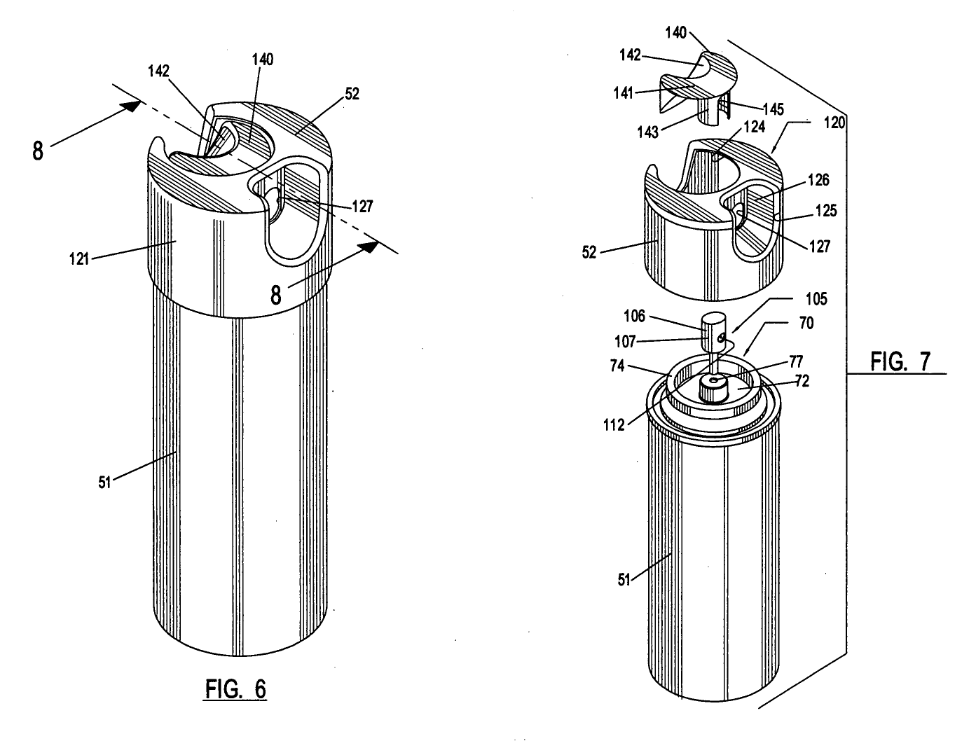

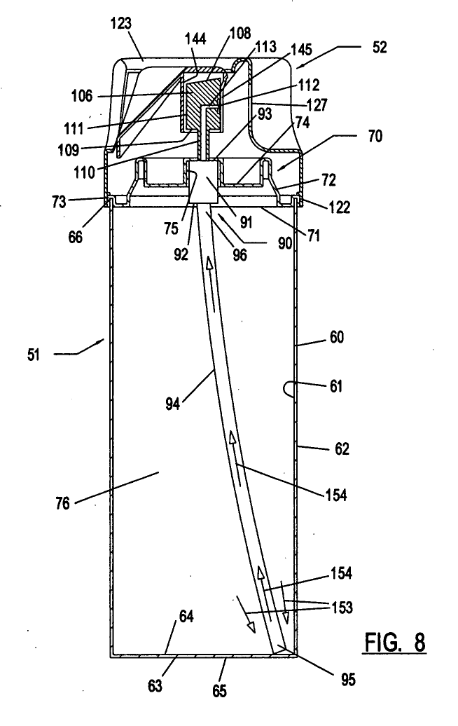

The canister portion 51 has an upper end wall 70 shown in FIGS. 7 and 8. The upper end wall is preferably metal and has an interior surface 71 and an opposite exterior surface 72. The upper end wall has a sealing or mounting ring 73 which is mounted on the upper annulus 66 in pressure tight relation extending thereabout. The upper end wall has a central pressure wall 74 inwardly of and concentric to the mounting ring. The interior surface of the upper end wall has a central receptacle 75 of predetermined size. The cylindrical side wall 60, bottom end wall 63 and upper end wall 70 bound an internal pressure chamber 76 of canister portion 51. The pressure chamber is fluid and pressure tight. A central opening 77 extends through the central pressure wall and communicates within the pressure chamber.

Referring more particularly to FIG. 8, the container 50 has valve assembly generally indicated by the numeral 90. The valve assembly has a cylindrical control housing 91 having a lower wall 92 and an upper wall 93. The control housing has an internal chamber, not shown, with passages individually extending through the lower wall and upper wall respectively. An internal spring having a sealing member, not shown, is captured in the internal chamber of the control housing. The sealing member is biased by the internal spring against the passage of the lower wall 92 in sealing relation thereto. The control housing is received in fitted relation in the central receptacle 75 of the canister portion 51 of the container 50. The valve assembly 90 has an intake tube 94 mounted on the lower wall 92 of the control housing and communicating with the internal chamber thereof through the passage in the lower wall. The intake tube has an intake end portion 95 within the internal pressure chamber 76 adjacent to the bottom end wall 63, as shown in FIG. 8. The intake tube has a discharge end portion 96 connected to the lower wall 92 of the control housing communicating with the internal chamber of the control housing through the passage of the lower wall. It will be understood that the intake tube is hallow and thus establishes a passage from the lower end portion of the internal pressure chamber 76 to the internal chamber control housing.

The valve assembly 90 has a discharge assembly 105 best shown in FIGS. 7 and 8. The discharge assembly has a main body 106 having a substantially cylindrical outer surface 107. The main body has a sloped upper surface 108 and a lower surface 109. A plunger 110 extends through the central opening 77 of the pressure wall 74 and into the passage of the upper wall 93 so as to communicate with the internal chamber of the control housing 91. A central passage 111 extends axially through the plunger and into the main body 106. An aperture or discharge nozzle 112 is mounted in the outer surface 107 of the main body and communicates with the central passage 111 through a discharge passage 113.

The discharge nozzle 112 in this illustrative embodiment is one adapted to produce a foam as will hereinafter be discussed in greater detail. Alternatively, the discharge nozzle can be of a type operable to produce a spray, a string of material, or any other configuration of discharge.

The cap portion 52 of the container 50 has a cap housing 120. The cap housing has an outer wall 121, of a generally cylindrical configuration, with a mounting ring 122 adapted to be snap-fitted on the mounting ring 73 of the upper end wall 70 of the canister portion 51. The cap housing has an upper wall 123 with a trigger member opening 124 and a discharge opening 125. The cap housing has a recessed wall 126 in which is formed a discharge opening 127.

The cap portion 52 of the container 50 has a trigger member 140 which is slidably received in the trigger member opening 124 for movement along an axis substantially parallel to the longitudinal axis of the cylindrical side wall 60 of the canister portion 51. The trigger member has an upper wall 141 and a rearwardly facing concave wall 142. A substantially cylindrical housing 143 is mounted on and extends downwardly from the upper wall 141. The cylindrical housing has an internal receptacle 144 dimensioned to receive the main body 106 therewithin, as shown in FIG. 8. The cylindrical housing 143 has a slotted opening 145 which faces forwardly to provide a passage extending from the discharge nozzle 112, through the slotted opening 145 and the discharge opening 127, as best shown in FIG. 8.

Referring more particularly to FIG. 1, for illustrative convenience, the apparatus 10 of the present invention is shown in a typical operative environment in the practice of the method of the present invention. As shown in FIG. 1, the brushing end portions 33 of the bristles 31 of the toothbrush 20 constitute a target or target area 150. As shown therein, it is desired to place a toothpaste, dentifrice or other work material on the target area. As shown in FIG. 1, a strand of a foam applying medium is indicated by the numeral 151. As shown therein, a bead or deposit of the foam applying medium 152 is being placed on the brushing end portions 33 of the bristles.

Referring more particularly to FIG. 8, for illustrative convenience, arrows 153 indicate the direction of movement of the contents of the canister portion 51 from the pressure chamber 76, as will hereinafter be described in greater detail. Arrows 154 similarly indicate the direction of movement of the contents of the canister portion 51 from the pressure chamber 76 upwardly through the intake tube 94.

The method of the present invention and the operation of the apparatus 10 of the present invention is hereinafter setforth.

The method of the present invention includes the use of a work material. In the illustrative example, the work material is a dentifrice which can be in the form of what is more commonly known as toothpaste, tooth powder, or can be any other dental substance. More broadly in other areas of application, the work material can be virtually any other substance which is desired to be applied to a target area for a given purpose.

In accordance with the method of the present invention, the work material is intermixed with a flowable carrier substance to form a flowable applying medium consisting of the work material and the carrier substance. It will be understood that the most efficacious work material and carrier substance depend upon the object to be achieved as well as the working characteristics of each. In the intermixing step of the illustrative example, however, the work material and carrier substance are preferably intermixed until a substantially homogeneous and flowable applying medium is formed consisting of the work material and carrier substance. Other additives can also be intermixed with the applying medium as necessary or desired. Where the work material is a dentifrice or toothpaste, for example, such additives as preservatives, flavorings, coloring agents and the like can be employed as desired.

The applying medium so formed is then placed in a suitable vessel as, for example, in the pressure chamber 76 of the apparatus 10 of the present invention. The applying medium is placed under pressure within the pressure chamber 76 by any suitable means. A suitable pressurized liquid or gas propellant can be used for this purpose. The amount of pressure applied is that sufficient for propelling the release of the applying medium from the apparatus.

Preferably, although not necessarily, employing the apparatus 10 of the present invention, the amount of pressure applied to the applying medium within the pressure chamber 76 is that sufficient to propel a strand of foam applying medium 151 from the discharge nozzle 112, as shown in FIG. 1. Alternatively, as heretofore noted, the discharge nozzle can be of a type operable to produce a spray, string, or any other configuration of discharged material. The strand of foam applying medium is believed to possess operative advantages, however, as herein set forth.

In addition, preferably although not necessarily, the amount of pressure applied to the applying medium within the pressure chamber 76 is that sufficient to cause the strand of foam to be released from the apparatus 10 at a rate of speed sufficient to maintain the continuity or cohesiveness of the strand. Similarly, the amount of pressure is such as to cause the strand of foam to be released at a relatively slow rate of speed so that the strand can readily be directed along a relatively narrow course under the control of the operator.

In accordance with the method of the present invention, use of the container 50 in the brushing of teeth takes place with a step best illustrated in FIG. 1. The container 50 is preferably positioned as shown therein so that the container is disposed with the discharge nozzle 112 facing substantially in a downward direction. The discharge nozzle is not positioned in contact with, or near contact with, the target area 150. In accordance with the method of the present invention, the discharge nozzle is spaced from the target area a substantially great distance, as shown in FIG. 1.

With this spacing being maintained, the apparatus 10 is operated to release the applying medium therefrom in the strand of foam on to the target area 150. Using the apparatus 10, this is achieved by depressing the concave wall 142 of the trigger member 140. This causes the main body 106 of the discharge assembly 105 to be depressed moving the plunger 110 thereof through the passage of the upper wall 93 to engage and press the sealing member within the control housing 91 of the valve assembly 90. This opens a passage from the pressure chamber 76, through the intake tube 94, the control housing 91, the central passage 111 of the main body 106, the discharge passage 113 and the discharge nozzle 112. The applying medium, under pressure within the pressure chamber, passes along this route and is discharged through the discharge nozzle 112 in the strand of foam 151. The strand of foam is directed by the operator, positioning the container 50, toward the target area 150 to form the bead of the applying medium 152 on the target area. During this operation, the spacing between the apparatus 10, including the discharge nozzle, and the target area is maintained. More particularly, the apparatus 10 and the toothbrush 20 are never brought into contact, or near contact, with each other.

Where the discharge nozzle 112 is that producing a spray, a string, or other configuration of applying medium, the same method of the present invention is employed. The discharge nozzles in these cases operate to cause the applying medium to be confined to a straight path of travel as in the case of the strand of foam 151. The straight path of travel is directed by the operator toward the target area for receipt therewithin.

The brushing end portions 33 of the bristles 31 receive the applying medium and retain it disposed for brushing. Substantially none of the applying medium passes outside of the target area. The foam applying medium is particularly well suited to maintaining the cohesiveness of the strand during aiming and discharge into the target area and for being received and retained by the brushing end portions of the bristles for brushing.

Since the apparatus 10 and the toothbrush, nor any portions thereof, never come into proximity to each other, contamination between the two cannot, or is highly unlikely to, take place. This permits both the apparatus and the toothbrush to be maintained in substantially more sanitary condition. The bristles 31 and interstices 34 of the toothbrush will not serve as a breeding ground for microorganisms to the degree that has in the past been considered as the norm. The transmission of communicable ailments among persons using the same dentifrice container, such as members of the same family, is much less likely to take place.

Therefore, the method and apparatus for applying a work material of the present invention permit the work material to be applied to a predetermined target area with accuracy and precision while minimizing the risk of contamination during such application; can be adapted to a wide variety of specific uses; have particular utility in dental usages; assist in improving dental hygiene beyond that which has heretofore been possible; and, for these and other reasons, afford a comfort in use which promotes optimum practices with regard to dental hygiene.

Although the invention has been herein shown and described in what is conceived to be the most practical and preferred embodiments, it is recognized that departures may be made therefrom within the scope of the invention which is not to be limited to the illustrative details disclosed.

Having described my invention, what I claim as new and desire to secure by Letters Patent is:

1. A method for applying a work material comprising the steps of:
intermixing said work material with a flowable carrier substance to form a flowable applying medium consisting of the work material and the carrier substance; and
housing the applying medium in a container selectively operable to permit release of the applying medium from the container for receipt on a target.

2. The method of claim 1 including the step after said housing step of:
spacing said target and container from each other prior to release of the applying medium therefrom so as to avoid contact between the target and the container.

3. The method of claim 1 wherein, in said housing step, the applying medium is placed under pressure within said container for propelling the selective release of the applying medium from the container.

4. The method of claim 3 wherein said pressure on the applying medium within the container is sufficient to propel the applying medium from the container a desired distance to the target disposed in spaced relation thereto so as to avoid contact between the container and the target.

5. The method of claim 4 wherein, in the intermixing step, the resulting applying medium has a consistency which permits said applying medium to be propelled from the container in a substantially continuous stream.

6. The method of claim 5 wherein, in the intermixing step, the resulting applying medium has a consistency permitting said applying medium to be released from the container along a substantially straight path as directed by an operator.

7. The method of claim 6 wherein the applying medium is propelled from the container substantially in a strand.

8. The method of claim 6 wherein the applying medium is propelled from the container substantially in a spray.

9. An apparatus for applying a work material comprising a container having an internal chamber communicating with the exterior of the container through an aperture; means mounted on the container for selectively opening and closing said aperture; and an applying medium housed within said chamber of the container having a consistency permitting release through the aperture of the container, upon operation of said opening and closing means, toward a target spaced therefrom.

10. The apparatus of claim 9 wherein said applying medium includes a work material intermixed with a flowable carrier substance so as to form a substantially continuous stream toward the target upon release through the aperture of the container.

11. The apparatus of claim 10 wherein said work material is a dentifrice and the target includes the bristles of a toothbrush.

12. The apparatus of claim 11 including pressurizing means in the internal chamber of the container operable to propel said applying medium from the internal chamber through said aperture upon selective operation of the opening and closing means.

13. The apparatus of claim 12 wherein said consistency of the applying medium and said pressurizing means cooperate to propel the applying medium from the internal chamber, upon operation of the opening and closing means, in a substantially continuous strand from the aperture to the bristles of the toothbrush spaced therefrom so as to avoid contact between said bristles of the toothbrush and the container.

14. The apparatus of claim 12 wherein said consistency of the applying medium and said pressurizing means cooperate to propel the applying medium from the internal chamber, upon operation of the opening and closing means, in a substantially continuous spray from the aperture to the bristles of the toothbrush spaced therefrom so as to avoid contact between said bristles of the toothbrush and the container.

15. The apparatus of claim 12 wherein said opening and closing means includes a valve assembly housing said aperture and having a conduit extending from the internal chamber of the container to the aperture.

16. The apparatus of claim 15 wherein said valve assembly has a plunger which can be depressed to propel said applying medium from the internal chamber of the container along said conduit and through the aperture.
